(19) United States
(12) Patent Application Publication
(10) Pub. No.: US 2026/0113160 A1
(43) Pub. Date: Apr. 23, 2026

(54) User Equipment Measurements during Network Antenna Muting

(71) Applicant: Telefonaktiebolaget LM Ericsson (publ), Stockholm (SE)

(72) Inventors: Rui Fan, Beijing (CN); Andres Reial, Hoellviken (SE); Ali Nader, Malmö (SE); Ilmiawan Shubhi, Malmoe (SE); Sina Maleki, Malmoe (SE); Jonas Bengtsson, Haeljarp (SE)

(21) Appl. No.: 18/873,492

(22) PCT Filed: Jul. 4, 2022
(86) PCT No.: PCT/CN2022/103730

§ 371 Date: Dec. 10, 2024

(51) Int. Cl. H04L 5/00; H04B 7/06; H04B 17/318; H04W 24/10

(52) U.S. Cl. CPC H04L 5/0051; H04B 7/0626; H04B 17/318; H04W 24/10

(57) ABSTRACT

Embodiments include methods for a user equipment, UE, configured to operate in a radio access network, RAN. Such methods include receiving, from a RAN node, a configuration for measurement and reporting by the UE. The configuration identifies the following: radio resources on which reference signals, RS, are or will be transmitted by the RAN node, and a mapping of the identified radio resources to a plurality of RAN node antenna ports used to transmit the RS. Such methods include determining that a first subset of the RAN node antenna ports are muted and subsequently refraining from receiving and measuring RS in radio resources that map to the first subset of RAN node antenna ports determined to be muted. Other embodiments include complementary methods for a RAN node, as well as UEs and RAN nodes configured to perform such methods.

### TECHNICAL FIELD

The present disclosure relates generally to wireless networks, and more specifically to techniques for user equipment (UE) to detect when a radio access network (RAN) node has muted transmissions on one or more of its antenna ports, and to manage UE measurements in the event of such muting.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with fourth-generation Long-Term Evolution (LTE). For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tracking reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

Initially, it was expected that NR networks would consume less energy than LTE networks due to so-called “lean design.” In current implementations, however, NR networks are likely consume more energy than LTE networks due to higher bandwidth and larger antenna arrays (e.g., increased number of antenna elements and transmit/receive antenna ports) and corresponding RF transmit/receive chains. To support UEs with maximum capability (e.g., throughput, coverage, etc.), a RAN node (e.g., base station) may need to use all available antenna ports and RF chains even though the maximum capability is rarely needed by UEs.

One consequence of using an increased number of transmit antenna ports is that the RAN node must transmit a larger number of RS (e.g., CSI-RS) to be measured by a UE for characterizing the DL channel. For example, CSI-RS are transmitted using logical arrangements of antenna ports known as “CSI ports.” Not only does this increase the RAN node energy consumption, but the larger number of DL RS consumes scarce DL radio resources that could otherwise be used for carrying DL data.

One goal of 3GPP Rel-18 is improving and/or reducing network energy consumption. One method that has been discussed is to dynamically adapt the number of configured logical and physical antenna ports used by a RAN node to reduce the RAN node's energy consumption. A RAN node stopping or pausing transmission on some of its antenna elements (or corresponding antenna ports) is often referred to as “muting.”

### SUMMARY

When a RAN node performs muting, a subset of configured CSI-RS ports may end up not carrying any signals. Although this benefits the RAN node's energy consumption, it can negatively impact UEs that are generally unaware that the RAN node is performing the muting. For example, UEs monitoring for transmissions on muted CSI-RS ports will collect invalid measurement samples and make invalid computations and/or decisions based on these invalid samples. For example, UE measurements collected for muted CSI-RS ports only contain interference and noise.

In typical deployments, it is expected that RAN node muting will be a medium-to-long-term action, such that UEs may collect and process invalid measurements on muted CSI-RS for extended periods of time. Thus, these UEs may consume a significant amount of energy while collecting and processing these invalid measurements on muted CSI-RS ports.

Embodiments of the present disclosure provide specific improvements to UE detection and management of muted RAN node antenna ports, such as by providing, enabling, and/or facilitating solutions to exemplary problems summarized above and described in more detail below.

Some embodiments include methods (e.g., procedures) for a UE configured to operate in a RAN.

These exemplary methods can include receiving, from a RAN node, a configuration for measurement and reporting by the UE, wherein the configuration identifies the following: radio resources on which reference signals (RS) are or will be transmitted by the RAN node, and a mapping of the identified radio resources to a plurality of RAN node antenna ports used to transmit the RS. For example, the RS can be CSI-RS and the RAN node antenna ports can be CSI-RS ports.

These exemplary methods can also include determining that a first subset of the RAN node antenna ports are muted and subsequently refraining from receiving and measuring RS in radio resources that map to the first subset of RAN node antenna ports determined to be muted. In some embodiments, these exemplary methods can also include, while refraining from receiving and measuring RS in the radio resources that map to the first subset, receiving and measuring the RS in the radio resources that map to a second subset of the RAN node antenna ports that were not determined to be muted.

Other embodiments include methods (e.g., procedures) for a RAN node configured to transmit RS to UEs.

These exemplary methods can include sending, to a UE, a configuration for measurement and reporting by the UE. The configuration identifies the following: radio resources on which RS are or will be transmitted by the RAN node, and a mapping of the identified radio resources to a plurality of RAN node antenna ports used to transmit the RS. For example, the RS can be CSI-RS and the RAN node antenna ports can be CSI-RS ports.

These exemplary methods can also include transmitting RS in the radio resources that map to the plurality of RAN node antenna ports. These exemplary methods can also include selecting a first subset of the RAN node antenna ports to be muted, based on one or more of the following:
a first portion of a RAN node antenna panel transmits no RS other than the first subset, and
one or more OFDM symbols include none of the configured radio resources other than the radio resources that map to the first subset.
   These exemplary methods can also include subsequently refraining from transmitting RS in radio resources that map to the first subset of RAN node antenna ports.

Other embodiments include UEs (e.g., wireless devices) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs and RAN nodes to perform operations corresponding to any of the exemplary methods described herein.

These and other embodiments described herein can advantageously reduce and/or eliminate invalid and/or irrelevant CSI-RS measurements by the UE on radio resources that map to muted RAN node antenna ports. This can reduce energy consumed by the UE and thus improve UE battery life (i.e., between charges) while avoiding channel estimation based on invalid CSI-RS measurements. Furthermore, embodiments do not require network intervention and/or configuration, so that the RAN node can mute and unmute antenna ports as needed and/or desired to reduced network energy consumption without concern about effects on UEs.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1A-1D show various arrangements for transmit beamforming.

FIG. 2 illustrates how a RAN node's logical and physical antenna ports can be muted to facilitate powering down the RAN node's radio parts.

FIG. 3 illustrates how different portions of a RAN node antenna panel may be muted.

FIG. 4 shows an exemplary time-frequency resource grid for an NR slot.

FIG. 5 shows four exemplary CSI-RS resource configurations.

FIG. 6, which includes FIGS. 6A-E, shows various exemplary ASN.1 data structures for message fields and/or information elements (IEs) used to provide CSI-RS resource set configurations to an NR UE.

FIG. 7 shows an exemplary ASN.1 data structure for a CSI-RS-ResourceConfigMobility IE, by which an NR network can configure a UE for CSI-RS-based radio resource management (RRM) measurements.

FIG. 8 shows an exemplary arrangement that illustrates various embodiments of the present disclosure.

FIG. 9 shows a flow diagram of an exemplary method (e.g., procedure) for a UE (e.g., wireless device), according to various embodiments of the present disclosure.

FIG. 10 shows a flow diagram of an exemplary method (e.g., procedure) for a RAN node (e.g., base station, eNB, gNB, ng-eNB, etc.), according to various embodiments of the present disclosure.

FIG. 11 shows a communication system according to various embodiments of the present disclosure.

FIG. 12 shows a UE according to various embodiments of the present disclosure.

FIG. 13 shows a network node according to various embodiments of the present disclosure.

FIG. 14 is a block diagram of a virtualization environment in which functions implemented by some embodiments of the present disclosure may be virtualized.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a radio access node or a wireless device.
Node: As used herein, a “node” can be a network node or a wireless device.
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (RAN node) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

5G/NR networks are expected to operate at higher frequencies such as 25-60 GHz, which are typically referred to as “millimeter wave” or “mmW” for short. Such systems are also expected to utilize a variety of multi-antenna technology (e.g., antenna arrays) at the transmitter, the receiver, or both. In general, multi-antenna technology can include a plurality of antennas in combination with advanced signal processing techniques (e.g., beamforming).

Availability of multiple antennas at the transmitter and/or the receiver can be utilized in different ways to achieve different goals. For example, multiple antennas at the transmitter and/or the receiver can be used to provide additional diversity against radio channel fading. To achieve such diversity, the channels experienced by the different antennas should have low mutual correlation, e.g., a sufficiently large antenna spacing (“spatial diversity”) and or different polarization directions (“polarization diversity”).

As another example, multiple antennas at the transmitter and/or the receiver can be used to shape or “form” the overall antenna beam (e.g., transmit and/or receive beam, respectively) in a certain way, with the general goal being to improve the received signal-to-interference-plus-noise ratio (SINR) and, ultimately, system capacity and/or coverage. This can be done, for example, by maximizing the overall antenna gain in the direction of the target receiver or transmitter or by suppressing specific dominant interfering signals. More specifically, the transmitter and/or receiver can determine an appropriate weight for each antenna element in an antenna array so as to produce one or more beams, with each beam covering a particular range of azimuth and elevation relative to the antenna array.

In relatively good channel conditions, the capacity of the channel becomes saturated such that further improving the SINR provides limited capacity improvements. In such cases, using multiple antennas at both the transmitter and the receiver can be used to create multiple parallel communication “channels” over the radio interface. This can facilitate a highly efficient utilization of both the available transmit power and the available bandwidth resulting in, e.g., very high data rates within a limited bandwidth without a disproportionate degradation in coverage. For example, under certain conditions, the channel capacity can increase linearly with the number of antennas and avoid saturation in the data capacity and/or rates. These techniques are commonly referred to as “spatial multiplexing” or multiple-input, multiple-output (MIMO) antenna processing.

There are three main beamforming techniques: analog, digital, and hybrid (a combination of analog and digital). Analog beamforming can compensate for high mmW pathloss, while digital precoding can provide additional performance gains necessary to achieve a reasonable coverage. The implementation complexity of analog beamforming is significantly less than digital since it can utilize simple phase shifters, but it is limited in terms of multi-direction flexibility (i.e., a single beam can be formed at a time and the beams are then switched in time domain), transmission bandwidth (i.e., not possible to transmit over a sub-band), inaccuracies in the analog domain, etc.

Digital beamforming requires more complex converters between the digital domain (i.e., OFDM FFT/IFFT) and the intermediate frequency (IF) radio domain. However, digital beamforming, which is often used today in LTE networks, provides the best performance in terms of data rate and multiplexing capabilities. For example, multiple beams over multiple sub-bands can be formed simultaneously. Even so, digital beamforming presents challenges in terms of power consumption, integration, and cost. Furthermore, while cost generally scales linearly with the number of transmit/receive units, the gains of digital beamforming increase more slowly.

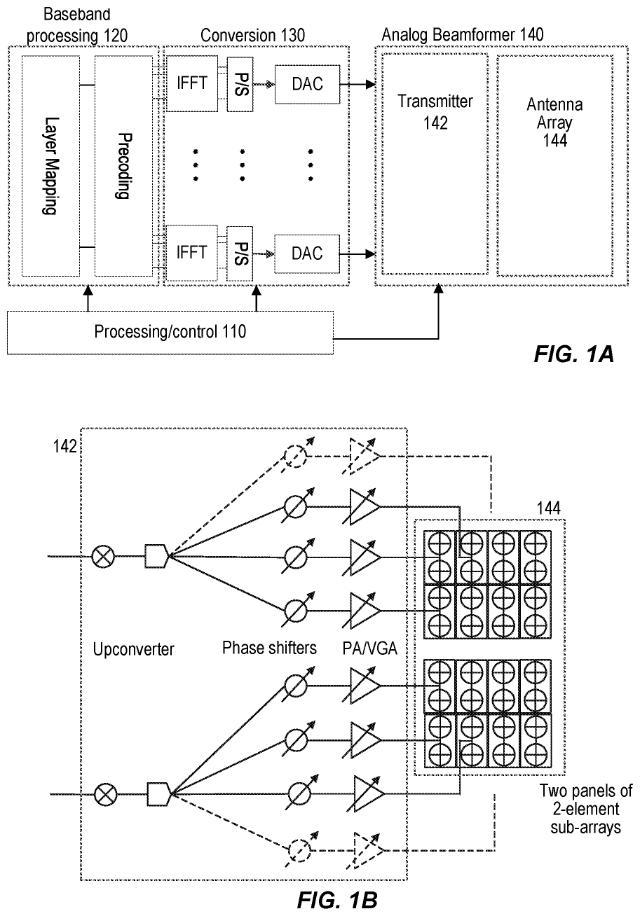

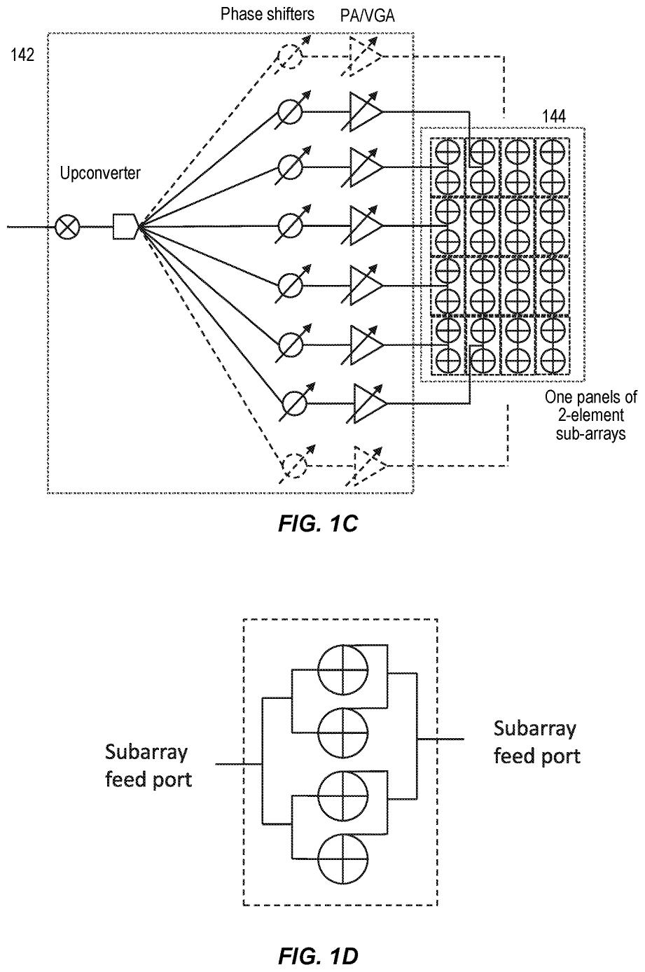

FIG. 1A shows an exemplary hybrid transmit beamforming arrangement, which includes baseband processing circuitry (120) coupled to an analog beamformer (BF, 140) via intermediate conversion circuitry (130). The baseband processing circuitry includes a MIMO-related functionality such as layer mapping and precoding. The conversion circuitry can include one or more conversion chains, with multiple conversion chains shown in the figure. Each conversion chain can include an inverse FFT, a parallel-to-serial (P/S) converter, and a digital-to-analog converter (DAC). The analog beamformer includes a transmitter (142, also referred to as transmit circuitry) and an antenna array (144). Additionally, the arrangement shown in FIG. 1 includes processing/control circuitry (110) that manages and/or controls the baseband processing circuitry, the conversion circuitry, and the transmitter.

FIG. 1B shows an exemplary arrangement of analog beamformer 140. In this arrangement, antenna panel 144 includes two panels (or sub-panels), with each panel including eight (8) two-element sub-arrays. Each antenna element provides vertical and horizontal polarization, as indicated by crosses in the respective circles. Transmitter 142 includes an independent beamforming circuit for each panel, with each beamforming circuit include an upconverter (e.g., mixer) from intermediate frequency (IF) to radio frequency (RF), as well as independent phase shifters and power amplifiers (PAs, also referred to as VGAs) for each two-element sub-array.

FIG. 1C shows another exemplary arrangement of analog beamformer 140. In this arrangement, antenna panel 144 includes one antenna panel with 16 two-element sub-arrays. Each antenna element provides vertical and horizontal polarization, as indicated by crosses in the respective circles. Transmitter 142 includes one beamforming circuit arranged in a similar manner as shown in FIG. 1B. In this exemplary arrangement, only a single conversion chain is needed in conversion circuitry 130 shown in FIG. 1A.

Note that the exemplary transmitters 142 shown in FIGS. 1B-C feed a single polarization on the antenna panel 144. Duplicate transmitters 142 can be used to feed the respective horizontal and vertical polarizations on the antenna panel 144.

FIG. 1D shows an alternative four-element sub-array that can be substituted for the two-element sub-arrays in either of FIGS. 1B and 1C. This four-element sub-array has two feed ports, one for vertical polarization of all four elements and the other for horizontal polarization of all four elements. Each feed port can be connected to one of the PAs shown in FIGS. 1B-1C.

Although the antenna arrays shown in FIGS. 1B-IC are two-dimensional grids of elements, this is only exemplary. Other exemplary antenna arrays can have linear and/or one-dimensional arrangements of elements.

A beamformer steers the analog beam of each antenna panel toward a single orientation or direction for each polarization on each OFDM symbol. For example, the processing/control circuitry can configure the phase shifters and the PAs associated with each subarray to generate a beam having a desired orientation. The number of subarrays in a panel determines the array gain for the panel. The arrangement shown in FIG. 1B supports one beam per panel per polarization (four total for two panels and two polarizations), while the arrangement shown in FIG. 1C supports only one beam per polarization (two total).

In LTE and NR, reference points for transmission of physical signals and channels are called “logical antenna ports”. This is an abstract concept invented by 3GPP, and the 3GPP specifications do not disclose how physical signals and channels defined at logical antenna ports are mapped to the physical antenna ports, which are the inputs to the antenna radiating elements.

A physical antenna port can be one or several antenna elements and a logical antenna port can receive input from more than one physical antenna port, hence from more than one antenna element or antenna element group. Only the logical antenna port can be observed and evaluated by a UE, based on evaluating received signals (e.g., CSI-RS) associated with the antenna port. The UE cannot directly see which physical antenna elements, physical antenna panels, subsections of antenna panels, etc. are used to transmit a given logical antenna port. A logical antenna port (or briefly “antenna port”) may be alternatively referred to by other terms such as “transmission port” and “CSI-RS port”.

As briefly mentioned above, a goal of 3GPP Rel-18 is improving and/or reducing network energy consumption. One method that has been discussed is to dynamically adapt the number of configured logical and physical antenna ports used by a RAN node (e.g., eNB or RAN node) in order to reduce the RAN node's energy consumption.

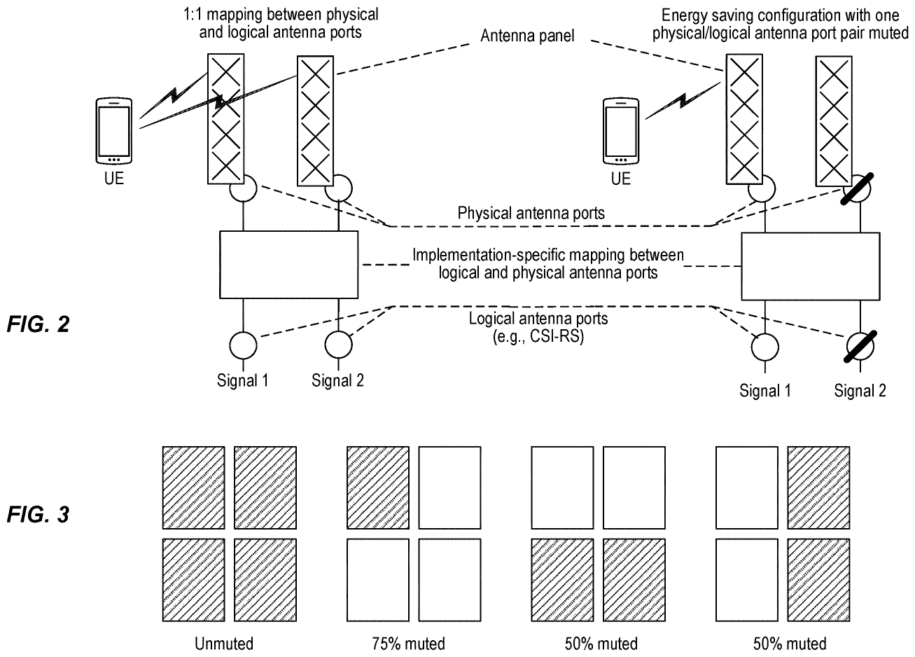

FIG. 2 illustrates how a RAN node's logical and physical antenna ports can be muted to facilitate powering down the RAN node's radio parts. The left side shows a conventional configuration in which two signals (Signal 1, 2) are input to two logical antenna ports of the RAN node, such as any of the logical antenna ports specified in 3GPP specifications. The RAN node applies a non-standardized, implementation-specific mapping of the two logical antenna ports to two physical antenna ports, which are the inputs to two antenna panels containing the antenna elements. In the left scenario, a single UE receives transmissions from both antenna panels, which includes the mapped version of Signals 1 and 2.

The right side of FIG. 2 shows an energy saving configuration in which the RAN node mutes the logical antenna port coupled to Signal 2, as well as the corresponding physical antenna port to the right antenna panel. This allows the RAN node to turn off the transmitter chain (including power amplifier) and receiver chain coupled to the muted ports, resulting in reduced energy consumption by the RAN node.

FIG. 3 shows various examples of how different portions of a RAN node antenna panel may be muted. In these examples, the antenna panel is subdivided into four equal-sized groups of antenna elements, with the groups arranged in a 2×2 grid. The left-most diagram shows the four groups unmuted (e.g., in normal operation), while the next diagram to the right shows three of the four groups (i.e., 75%) being muted. The two right-most diagrams show different arrangements of two groups (i.e., 50%) being muted. Other muting arrangements are also possible. In any case, the RAN node may turn off and/or deactivate RF circuitry (e.g., as shown in FIGS. 1A-C) that drives the muted groups of antenna elements.

As briefly mentioned above, 5G/NR technology shares many similarities with LTE. For example, NR uses CP-OFDM in the DL and both CP-OFDM and DFT-spread OFDM (DFT-S-OFDM) in the UL. As another example, NR DL and UL time-domain physical resources are organized into equal-sized 1-ms subframes. A subframe is further divided into multiple slots of equal duration, with each slot including multiple OFDM-based symbols.

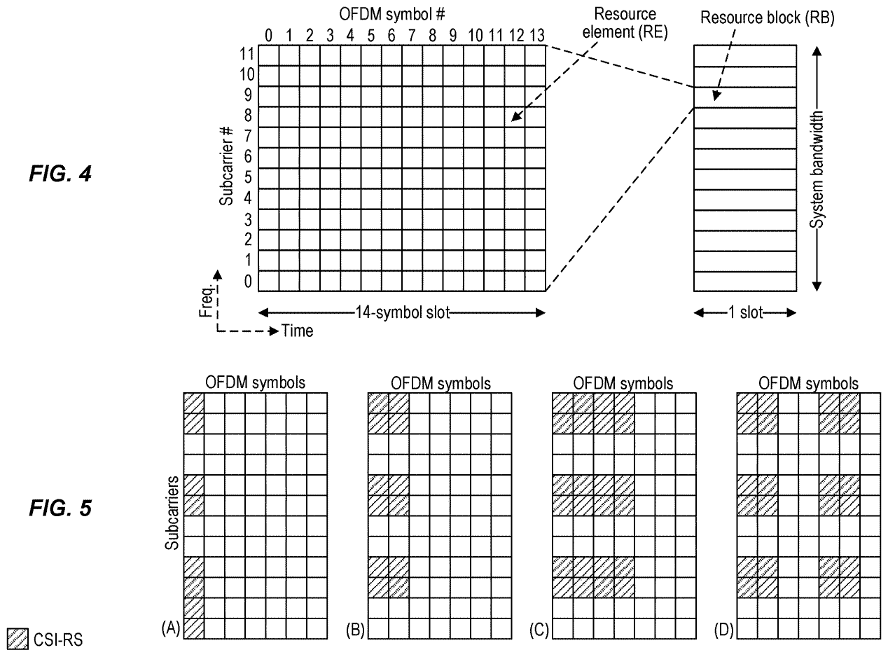

FIG. 4 shows an exemplary time-frequency resource grid for an NR slot. As illustrated in FIG. 4, a resource block (RB) consists of a group of 12 contiguous OFDM subcarriers for a duration of a 14-symbol slot. Like in LTE, a resource element (RE) consists of one subcarrier in one slot. An NR slot can include 14 OFDM symbols for normal cyclic prefix and 12 symbols for extended cyclic prefix.

In general, an NR physical channel corresponds to a set of REs carrying information that originates from higher layers. Downlink (DL, i.e., RAN node to UE) physical channels include Physical Downlink Shared Channel (PDSCH), Physical Downlink Control Channel (PDCCH), and Physical Broadcast Channel (PBCH).

PDSCH is the main physical channel used for unicast DL data transmission, but also for transmission of RAR (random access response), certain system information blocks (SIBs), and paging information. PBCH carries the basic system information (SI) required by the UE to access a cell. PDCCH is used for transmitting DL control information (DCI) including scheduling information for DL messages on PDSCH, grants for UL transmission on PUSCH, and channel quality feedback (e.g., CSI) for the UL channel.

Uplink (UL, i.e., UE to RAN node) physical channels include Physical Uplink Shared Channel (PUSCH), Physical Uplink Control Channel (PUCCH), and Physical Random-Access Channel (PRACH). PUSCH is the uplink counterpart to the PDSCH. PUCCH is used by UEs to transmit uplink control information (UCI) including HARQ feedback for RAN node DL transmissions, channel quality feedback (e.g., CSI) for the DL channel, scheduling requests (SRs), etc. PRACH is used for random access preamble transmission.

Within the NR DL, certain REs within each subframe are reserved for the transmission of RS. These include demodulation RS (DM-RS), which are transmitted to aid the UE in the reception of an associated PDCCH or PDSCH. Other DL reference signals include positioning RS (PRS) and channel state information RS (CSI-RS), the latter of which are monitored by the UE for the purpose of providing channel quality feedback for the DL channel. Additionally, phase-tracking RS (PTRS) are used by the UE to identify common phase error (CPE) present in sub-carriers of a received DL OFDM symbol.

Other RS-like DL signals include Primary Synchronization Sequence (PSS) and Secondary Synchronization Sequence (SSS), which facilitate the UEs time and frequency synchronization and acquisition of system parameters (e.g., via PBCH). The PSS, SSS, and PBCH are collectively referred to as an SS/PBCH block (SSB).

NR UEs in RRC_CONNECTED state can be configured by the serving RAN node with a set of CSI-RS resources for measuring the DL channel and providing channel quality information to the RAN node. FIG. 5 shows four exemplary CSI-RS resource configurations within a range of 12 contiguous sub-carriers and seven contiguous OFDM symbols (e.g., half RB in time domain). The left-most configuration includes CSI-RS resources in a single OFDM symbol, while the neighboring configuration includes CSI-RS resources in two contiguous OFDM symbols. The two right-most configurations include CSI-RS resources in four OFDM symbols, which may be contiguous or arranged in two groups of two.

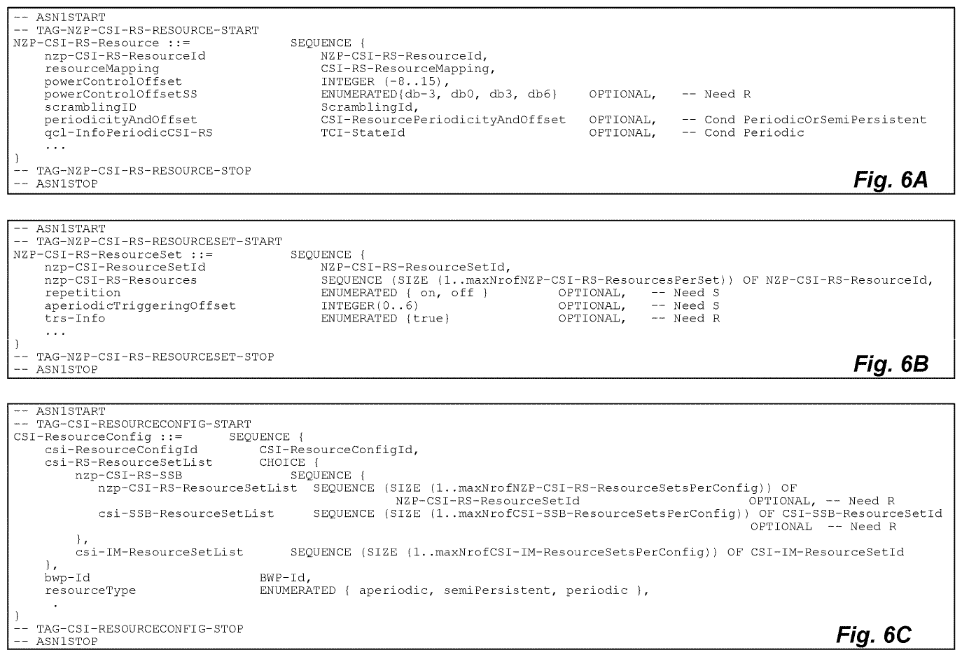

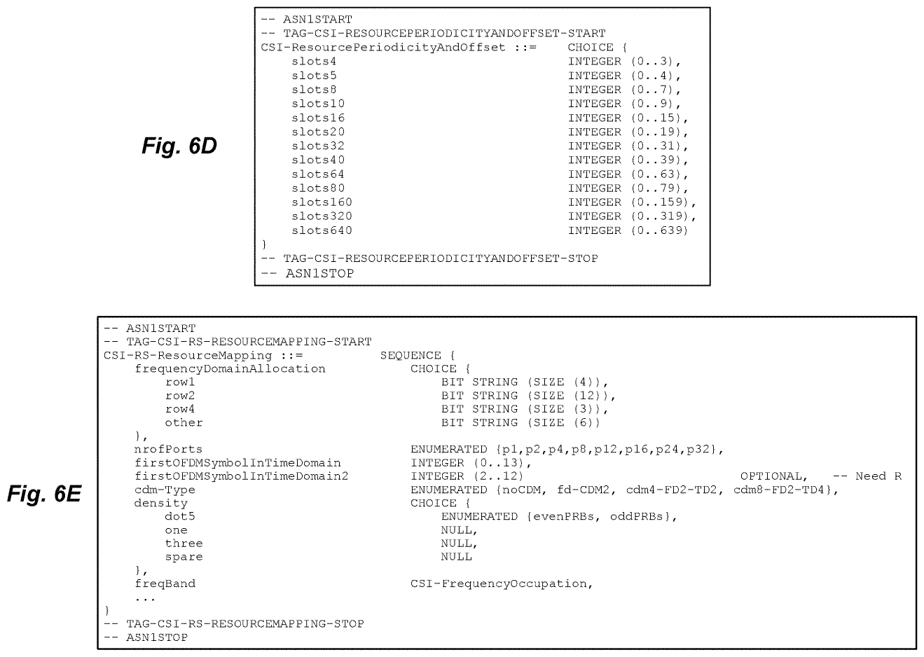

More specifically, an NR UE in RRC_CONNECTED state can be configured by the network with one or more NZP (non-zero power) CSI-RS resource set configurations by the higher-layer (e.g., RRC) information elements (IEs) NZP-CSI-RS-Resource. NZP-CSI-RS-ResourceSet. and CSI-ResourceConfig. Exemplary ASN.1 data structures representing these IEs are shown in FIGS. 6A-C, respectively.

Each NZP CSI-RS resource set consists of K≥1 NZP CSI-RS resources. The following parameters are included in the RRC IEs NZP-CSI-RS-Resource. CSI-ResourceConfig. and NZP-CSI-RS-ResourceSet for each CSI-RS resource configuration:
nzp-CSI-RS-ResourceId determines CSI-RS resource configuration identity. This identifier can have any value from zero up to one less than the maximum number of configured NZP CSI-RS resources (maxNrofNZP-CSI-RS-Resources).
nzp-CSI-RS-ResourceSetId determines CSI-RS resource set configuration identity. This identifier can have any value from zero up to one less than the maximum number of configured NZP CSI-RS resource sets (maxNrofNZP-CSI-RS-ResourceSets).
CSI-RS-ResourceConfigId is used to identify a specific CSI-ResourceConfig. This identifier can have any value from zero up to one less than the maximum number of CSI-RS resource configurations (maxNrofCSI-RS-ResourceConfigurations).
periodicityAndOffset defines the CSI-RS periodicity and slot offset for periodic/semi-persistent CSI-RS. All the CSI-RS resources within one set are configured with the same periodicity, while the slot offset can be same or different for different CSI-RS resources.

In addition, FIGS. 6D-E show exemplary ASN.1 data structures representing CSI-ResourcePeriodicityAndOffset and CSI-RS-ResourceMapping fields, of which the periodicityAndOffset and resourceMapping fields in the NZP-CSI-RS-Resource IE in FIG. 6A are examples. The CSI-ResourcePeriodicityAndOffset field is used to configure a periodicity and a corresponding offset for periodic and semi-persistent CSI resources, and for periodic and semi-persistent CSI reporting on PUCCH. Both periodicity and the offset are given in numbers of slots. For example, periodicity value “slots4” corresponds to four (4) slots, “slots5” corresponds to five (5) slots, etc.

The resourceMapping field in FIG. 6A defines the number of ports, CDM-type, and OFDM symbol and subcarrier occupancy of the CSI-RS resource within a slot. These parameters are further specified in the ASN.1 data structure for the CSI-RS-ResourceMapping field shown in FIG. 6E, with some of these parameters summarized as follows:
nrofPorts defines the number of CSI-RS ports, where the allowable values are given in 3GPP TS 38.211 (v16.3.0) section 7.4.1.5.
density defines CSI-RS frequency density of each CSI-RS port per PRB, and CSI-RS PRB offset in case of the density value of ½, where the allowable values are given in 3GPP TS 38.211 (v16.3.0) section 7.4.1.5. For density ½, the odd/even PRB allocation indicated in density is with respect to the common resource block grid.
cdm-Type defines code divisional multiplexing (CDM) values and pattern, where the allowable values are given in 3GPP TS 38.211 (v16.3.0) 7.4.1.5.
firstOFDMSymbolInTime Domain and lastOFDMSymbolInTime Domain specify first and last OFDM symbols in which CSI-RS resources are allocated in a timeslot.

All CSI-RS resources within one set are configured with same density and same nrofPorts, except for the NZP CSI-RS resources used for interference measurement. Furthermore, the UE expects that all the CSI-RS resources of a resource set are configured with the same starting RB and number of RBs and the same cdm-type.

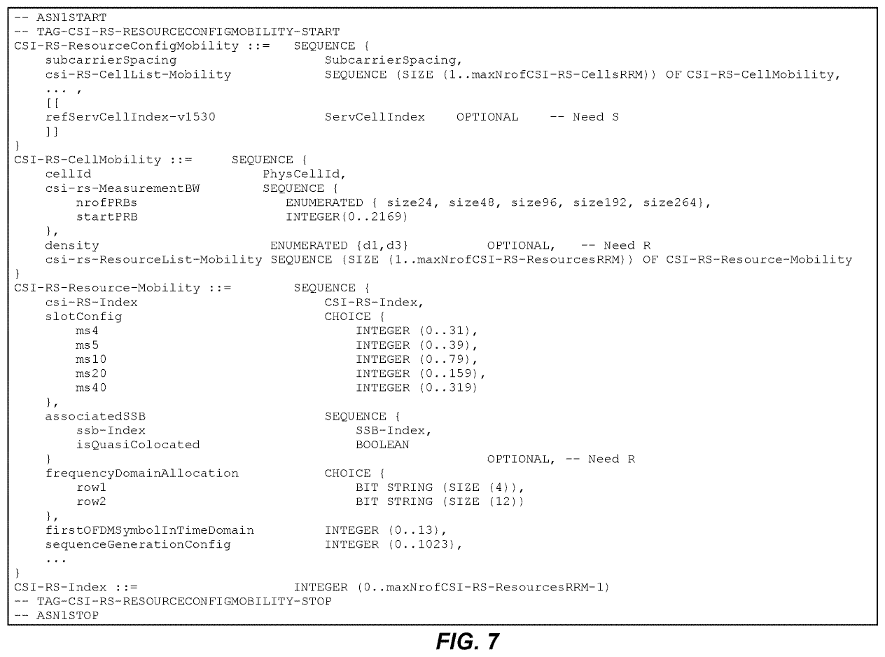

FIG. 7 shows an exemplary ASN.1 data structure for an RRC CSI-RS-ResourceConfig-Mobility IE, by which an NR network can configure a UE for CSI-RS-based radio resource management (RRM) measurements.

To summarize, a CSI-RS resource may configured to span one, two, or four OFDM symbols. The number of symbols is also dependent on the number of CSI-RS (antenna) ports configured in nrofPorts, as summarized below:
one symbol for 1, 2, 4, 8, 12 ports;
two symbols for 4, 8, 12, 16 ports; and
four symbols for 24, 32 ports.
   A CSI-RS resource may be configured to start at any OFDM symbol (0-13) of a slot, as defined by:
a single start symbol index for 1-symbol CSI-RS, 2-symbol CSI-RS, and 4-symbol contiguous CSI-RS with orthogonal cover code (T-OCC) span 4; and
two start symbol indices for 4-symbol CSI-RS 2+2 with T-OCC span 2.
   A CSI-RS resource can be mapped to frequency resources with granularity of 1, 2, or 4 subcarriers, with the same subcarriers being used across all OFDM symbols in which the CSI-RS resource is present. FIG. 5 described above shows various examples of CSI-RS resource mapping within a resource block.

Once configured with periodic, semi-periodic, and/or aperiodic NZP CSI-RS in the manner described above, an NR UE in RRC_CONNECTED state uses these CSI-RS to measure channel quality and/or to adjust the UE's time and frequency synchronization with the UE's serving network node (e.g., RAN node). Table 1 below summarizes relations between CSI reporting and different types of CSI-RS configurations.

TABLE 1

| CSI-RS | Periodic | | |
|---|---|---|---|
| Configu- | CSI | Semi-Persistent CSI | Aperiodic CSI |
| ration | Reporting | Reporting | Reporting |
| Periodic | No | For reporting on | Triggered by DCI; |
| CSI-RS | dynamic | PUCCH, the UE receives | additionally, |
| | triggering/ | an activation command, | subselection indication |
| | activation | as described in 3GPP TS | as described in 3GPP |
| | | 38.321 section 6.1.3.16; | TS 38.321 section |
| | | for reporting on PUSCH, | 6.1.3.13 possible as |
| | | the UE receives | defined in section |
| | | triggering on DCI | 5.2.1.5.1. |
| Semi- | Not | For reporting on | Triggered by DCI; |
| Persistent | Supported | PUCCH, the UE receives | additionally, |
| CSI-RS | | an activation command, | subselection indication |
| | | as described in 3GPP TS | as described in 3GPP |
| | | 38.321 section 6.1.3.16; | TS 38.321 section |
| | | for reporting on PUSCH, | 6.1.3.13 possible as |
| | | the UE receives | defined in section |
| | | triggering on DCI | 5.2.1.5.1. |
| Aperiodic | Not | Not | Triggered by DCI; |
| CSI-RS | Supported | Supported | additionally, |
| | | | subselection indication |
| | | | as described in 3GPP |
| | | | TS 38.321 section |
| | | | 6.1.3.13 possible as |
| | | | defined in section |
| | | | 5.2.1.5.1. |

However, when a RAN node performs muting, a subset of configured NZP CSI-RS ports may end up not carrying any signals. Although this benefits the RAN node's energy consumption, it can negatively impact UEs that are generally unaware that the RAN node is performing the muting. For example, UEs monitoring for transmissions on muted CSI-RS ports will collect invalid measurement samples and make invalid computations and/or decisions based on these invalid samples. In particular, UE measurements collected for muted CSI-RS ports only contain interference and noise.

In the case of 32 configured ports, the full set of ports are mapped to CSI-RS resources in four OFDM symbols such as shown in FIG. 3. If the RAN node mutes 16 of the configured ports, the unmuted 16 CSI-RS ports may map to resources in less than all of the four symbols (e.g., only two symbols). In the case of 12 or 16 configured ports, only one symbol may include CSI-RS resources that merit UE measurement and processing.

In some instances, the RAN node may provide multiple CSI-RS configurations to UEs, e.g., a first configuration for a first number of ports, a second configuration for a second number of ports, etc. However, this approach increases RRC signaling overhead and UE/RAN node complexity in managing the multiple CSI-RS configurations per UE. Performing the RAN node antenna muting without informing the UE is thus preferable in some scenarios.

In typical deployments, it is expected that RAN node muting will be a medium-to-long-term action, such that UEs may collect and process invalid measurements on muted CSI-RS for extended periods of time. Thus, these UEs may consume a significant amount of energy while collecting and processing these invalid measurements on muted CSI-RS ports.

Embodiments of the present disclosure address these and other problems, issues, and/or difficulties by providing techniques for UE that is configured with a CSI-RS transmitted on a plurality of RAN node antenna ports to determines that a first subset of the antenna ports do not carry any CSI-RS due to antenna muting by the RAN node. The UE may determine this, for example, based on observing substantially zero energy received on those ports or based on measurement reporting configuration. The UE then refrains from receiving and measuring CSI-RS on radio resources that map to the first subset determined to be muted, while continuing to receive and measure CSI-RS on radio resources that map to a second subset of the plurality of antenna ports that were not determined to be muted.

Embodiments of the present disclosure can provide various benefits, advantages, and/or solutions to various problems. For example, embodiments can reduce and/or eliminate invalid and/or irrelevant CSI-RS measurements by the UE of CSI-RS on radio resources that map to muted RAN node antenna ports. This reduces energy consumed by the UE and consequently improves UE battery life (i.e., between charges) while avoiding channel estimation based on invalid CSI-RS measurements. Furthermore, embodiments do not require network intervention and/or configuration, so that the RAN node can mute and unmute antenna ports as needed and/or desired to reduced energy consumption without concern about effects on UEs.

The following scenario provides a context for implementation and/or deployment of embodiments of the present disclosure. A RAN node (e.g., RAN node) configures a UE in RRC_CONNECTED state (or similar state in which the UE has a connection with the RAN) with a valid CSI-RS measurement configuration via dedicated RRC signaling. Since this configuration has relatively high signaling overhead (e.g., as shown in FIGS. 6A-E), it is preferrable to avoid frequent updates and thus is targeted for full-performance operation of the UE and the RAN node.

In time intervals when the load is lower and/or reduced transmit power or spatial resolution is sufficient, the RAN node may turn off some antenna element groups, e.g., 50% of the RAN node's antenna panel such as shown in FIG. 3. The RAN node may maintain antenna muting at its discretion, e.g., until the load increases or higher performance is required. Since the muting duration may or may not be long (and may not be known in advance), it is desirable for the RAN node to avoid reconfiguring all connected UEs twice per antenna muting cycle. Note that there is no low-overhead CSI-RS configuration switching mechanism. According to embodiments of the present disclosure, the RAN node performs the muting/unmuting without explicitly informing UEs, e.g., without changing CSI-RS configurations. In some cases, the muting duration may be relatively long, e.g., minutes or hours.

Although not described in 3GPP specifications, RAN node antenna muting is permitted within the specified framework. Furthermore, there is no impact to the RAN node if a UE continues to measure (and possibly report) CSI feedback for CSI ports that map to muted antenna elements, since the RAN node is aware of the muting status of these ports. Nevertheless, according to embodiments of the present disclosure, ae UE may detect that that a RAN node is muting configured CSI-RS (antenna) ports and exploit this to reduce UE energy consumption by subsequently refraining from receiving and measuring CSI-RS on radio resources that map to the muted RAN node antenna ports. In contrast, a “legacy” UE (i.e., without capabilities according to embodiments of the present disclosure) performing CSI measurements and reporting according to its configuration will continue receiving and measuring CSI-RS on radio resources that map to muted RAN node antenna ports.

In general, embodiments are applicable to CSI-RS measurements for beam management (BM), link adaptation (LA), radio resource measurements (RRM), or other procedures. Even so, the physical interpretation of antenna ports may vary in these procedures. For example, in LA, a port may map to a precoded or non-precoded transmission option, used by the UE to determine the preferred spatial precoding configuration. In BM, a port may map to a candidate beam in the serving cell. In RRM, a port may map to a candidate cell or sector for layer 3 (L3) mobility management.

In some embodiments, a UE can receive from a RAN node a configuration for measurement and reporting by the UE. This configuration can identify radio resources on which RS (e.g., CSI-RS) are or will be transmitted by the RAN node, and a mapping of the identified radio resources to a plurality of RAN node antenna ports (e.g., CSI-RS ports) used to transmit the RS. For example, the configuration can identify radio resources by OFDM symbol offset, period, frequency (SC range), scrambling sequence, etc.

In some embodiments, the configuration can identify radio resources that are periodic or semi-persistent in time, as well as a schedule for reporting UE measurements of the RS transmitted on the radio resources. This can include number of ports to report, reporting period, reporting conditions/thresholds/events, etc. In some embodiments, the configuration can also identify a UE procedure associated with the UE measurements to be reported, such as LA, BM, RRM, etc.

Subsequently, the UE can begin receiving and measuring RS in the radio resources identifies by the configuration. At some point, the UE can determine that a first subset of the RAN node antenna ports are muted, i.e., the RAN node is transmitting no signal energy on the first subset of antenna ports. This can be done in various ways according to different embodiments, as described below.

In some embodiments, the UE may observe that despite being configured with a periodic- or semi-persistent CSI-RS configuration, the reporting is not configured to be periodic. Rather, the RAN node configures semi-persistent/aperiodic CSI reporting (i.e., two right-most columns in two upper-most rows of Table 1). The UE may further detect that the RAN node at occasions deviates from the report ordering, e.g., despite configured resources, the RAN node does not ask for reports on certain resources. The UE may further detect that during such occasions, the UE measure zero or very low power/quality on these CSI-RS resources, as compared to previous measurements on these resources. Based on this information, the UE detects that the corresponding antenna ports are muted by the RAN node during these periods.

In some embodiments, the UE may collect measurements associated with various antenna ports over time and use these to determine whether individual antenna ports are muted or unmuted. The UE may monitor received power (or other quality estimate) for an antenna port over a predetermined number of measurements (e.g., 10-50) or over a predetermined duration (e.g., 0.5-2 s). In some embodiments, when the average received power is below a minimum threshold, the port may be considered muted. Alternatively, the port may be considered muted when the largest one or more measurements during the monitoring duration are below a minimum threshold.

In different variants, the UE may apply a model-based or non-model-based change detection mechanism. For example, the UE may note that the power received from specific ports follow an expected statistical distribution, e.g., a with a specific mean and variance. The UE can detect port muting when the actual statistical distribution of the received power measurements deviate from the expected statistical distribution by more than a threshold amount.

In another example, the UE may calculate the eigenvalues of the channel estimate matrix based on measurements associated with the configured plurality of antenna ports. The UE can detect that a specific port is muted based on a corresponding one of the eigenvalues being below a minimum threshold. An antenna port can also appear as muted when the channel between that port and the UE is momentarily blocked, so the UE may also require the eigenvalue(s) to be below the minimum threshold for at least a minimum duration before considering the corresponding port(s) to be muted. The minimum duration can be a number of CSI-RS occasions, a time window (e.g., a number of ms, secs), etc.

In some embodiments, the UE may also consider the number of ports in which a condition associated with muting is detected. For example, the UE determines that port muting is occurring only if near-zero power is detected in more than 4 ports. Alternately, this determination may be based on a minimum number that scales with or is proportional to the total number of configured antenna ports. For example, if the number of configured CSI-RS ports is 16, then the UE may determine that port muting occurs when the condition (e.g., near-zero power) is detected for 4 or more ports: while if the number of configured CSI-RS ports is 32, the UE may determine that port muting occurs when the condition is detected for 8 or more ports. As a specific example, this threshold can be a fixed fraction of the configured number of antenna ports.

Alternately, this determination may be based on a minimum percentage of the total number of configured antenna ports. For example, the UE may determine that port muting occurs when the condition is detected in at least 50% of the configured CSI-RS ports.

Alternately, this determination may be based on the condition being detected in a numerical pattern of antenna ports. For example, the configured antenna ports can be associated with respective port indices. If 32 ports are configured and the UE detects the relevant condition in ports 0-15 but not in ports 16-31, then the UE may determine that port muting occurs. In another example, the UE may determine that port muting occurs when the relevant condition is detected in even-numbered ports but not in odd-numbered ports, and/or vice versa. In contrast, the UE determines no port muting when the relevant condition is detected in ports with indices that have no apparent relationship (e.g., random). Other numerical patterns or non-patterns may also be employed for muting determination.

In some embodiments, received power thresholds for detecting muting may be relative, e.g., to an estimation noise floor and/or to the largest received power. Alternatively, the threshold may be an absolute value. The thresholds can be determined such that the resulting misdetection rate and false alarm rate remain below first and second thresholds, e.g., 0.1 and 0.01. The false alarm detection in this case can be costlier for the UE, that is why it make sense that the second threshold is smaller or equal to the first threshold.

In some embodiments, the UE may periodically or occasionally verify that a port previously identified as muted remains muted. The UE may perform this verification every N configured measurement occasion, every M seconds, etc. If the relevant condition (e.g., received power) for the port remains below a threshold (which may higher than the threshold for initial muting detection to account for instantaneous measurement noise), the UE maintains its determination that the port is muted. Otherwise, the UE determines that the port is no longer muted.

In some embodiments, the UE may store its antenna port muting determinations associated with the cell in which the UE is operating (i.e., the cell served by the RAN node). After leaving and returning to the cell, or entering and returning from RRC_IDLE/RRC_INACTIVE, the UE may use the stored antenna port muting determinations as a starting point, verifying whether the same ports are still muted. Starting with the stored muting determinations may be further conditioned on proximate times of day, i.e., before and after the UE's transition.

In some embodiments, once the UE observes that the RAN node has muted one or more antenna ports, the UE observes for how long time the RAN node typically keeps these ports muted. In some embodiments, the UE further correlates the muting duration with other actions. For example, the UE may detect that if the UE is in a static radio environment, the ports are kept muted for a relatively long duration, whereas during UE movement (e.g., beam change, TCI state change, UE CSI report including larger than a certain change in measured quality) the RAN node turns on previously muted antenna ports.

In some embodiments, the UE keeps track of changes in a second subset of non-muted ports when the first subset of ports are muted or turned on again. For example, the UE may observe that the DMRS of PDCCH and/or PDSCH and CSI-RS on the second subset of non-muted ports have a first power level while the first subset of ports are muted. Similarly, the UE can observe that the DMRS of PDCCH and/or PDSCH and CSI-RS on the second subset of non-muted ports have a second power level while the first subset of ports are not muted. The UE can store these observations and use them as patterns for detecting similar conditions that correlate with muting or non-muting of antenna ports.

In some embodiments, the UE may observe that while the first subset of antenna ports are muted, the number of SSBs are different compared to when the first subset are not muted. For example, the UE detects eight (8) SSBs transmitted by the RAN node when no antenna ports are muted but a fewer number of SSBs (e.g., 1-4) when the first subset are muted. In some embodiments, the UE can verify antenna port muting determinations based on receiving (or not receiving) other signals associated with an antenna ports, such as SSB or data.

Once the UE determines that the first subset of RAN node antenna ports (i.e., of the configured RAN node antenna ports) are muted, the UE refrains from receiving and measuring RS in radio resources that map to the first subset of antenna ports. In some embodiments, while refraining from receiving and measuring RS in the radio resources that map to the first subset, the UE can continue receiving and measuring the RS in the radio resources that map to the second subset of the RAN node antenna ports that were not determined to be muted.

In general, the radio resources configured for RS transmission are included in various OFDM symbols of a slot, such as shown in FIG. 5. In some embodiments, the UE determines whether any of the OFDM symbols with configured RS transmissions only include radio resources that map to the first subset of antenna ports determined to be muted. In other words, the UE determines if any of the OFDM symbols do not include radio resources that map to a second subset of the configured antenna ports that were not determined to be muted. In case the UE determines that no unmuted ports can be measured in an OFDM symbol, the UE can switch its radio receiver to a low-energy state (e.g., powered-down, light sleep, deep sleep, etc.) during that OFDM symbol and possibly other adjacent symbols.

Alternately or additionally, the UE can refrain from measuring radio resources associated with the muted ports during other OFDM symbols that include radio resources associated with the unmuted ports. In some embodiments, when every OFDM symbol includes radio resources that map to the unmuted second subset of antenna ports, the UE can refrain from baseband processing the sampled contents of radio resources that map to the muted first subset. In other words, the UE only processes the configured radio resources in the OFDM symbol that map to the unmuted second subset. In such case, the UE can set the quality estimate associated with non-sampled or non-processed muted antenna ports to zero or a minimum non-zero value.

In some embodiments, the UE can send to the RAN node an indication that the UE determined that the first subset of the RAN node antenna ports are muted. In some embodiments, the UE can report actual or average UE measurement values corresponding to RAN node antenna ports of the muted first subset. In other embodiments, the UE can report zero or minimum UE measurement values that are representative of RAN node antenna port muting. In other embodiments, the UE can use specific patterns of reporting to indicate that the UE determined that the first subset of the RAN node antenna ports are muted. For example, the UE can report a preferred precoder associated with less than all of the configured RAN node antenna ports. As a more specific example, if 32 antenna ports are configured, the UE can report a preferred 16-ports precoder. As another example, the UE can report a preferred channel rank (e.g., 8) associated with less than all configured RAN node antenna ports (e.g., 16).

In some scenarios, below-threshold power estimates for a RAN node antenna port may also occur due to high path loss over the propagation channel between the antenna port and the UE. Omitting measurements on such ports is also desirable for reducing UE energy consumption. In such scenarios, however, the channel may vary when the UE changes position, at time scales that are faster than the antenna muting changed at the RAN node.

In some embodiments, the UE may condition the omission of receiving and measuring RS in radio resources that map to the first subset determined to be muted based on various conditions in order to avoid robustness problems. In other words, when the UE determines that one or more of such conditions exist, the UE continues receiving and measuring RS in radio resources that map to the first subset. Such conditions can include:
average or minimum RS received power (RSRP) and/or RS received quality (RSRQ) measured for the first subset is below a threshold;
average or minimum RSRP and/or RSRQ measured for other RS (e.g., SSB) are below a threshold;
the UE is static or moving more slowly than a threshold speed; and
one or more specific services or applications are running in the UE.

For example, the UE's physical movement (linear or rotational), or the lack of it, may be detected by observing channel estimates or using internal inertial sensors. When the UE detects speed of movement, accumulated distance moved, rotation rate or accumulated rotation exceeding a threshold, the UE may return to conventional measurement and reporting, without attempting to detect muted antenna ports.

In some embodiments, the UE may determine that port muting is occurring when the power of an antenna port changes abruptly but remains consistent before and after the change. In such case, the static condition may be omitted and the UE may skip measurements on the port while in the cell coverage area.

In some embodiments, the UE can resume receiving and measuring RS in radio resources that map to antenna ports previously determined to be muted (e.g., first subset) based on detecting one or more of various conditions. Some examples are discussed below.

In some variants, the UE can resume the receiving and measuring based on determining that the first subset of RAN node antenna ports are no longer muted. For example, this determination can be based on receiving and measuring RS in a first portion of the radio resources that map to the first subset, e.g., one of every N≥2 consecutive instances of the radio resources that map to the first subset, one instance per predetermined time period, etc.

In some variants, the UE can resume the receiving and measuring based on detecting that a number of synchronization signals (e.g., SSB) broadcast by the RAN node is at least a minimum threshold associated with the plurality of RAN node antenna ports being unmuted.

In some variants, the UE can resume the receiving and measuring based on detecting one or more of the following conditions for received power measured by the UE on radio resources that map to the second subset (i.e., that were not determined to be muted):
maximum is below a first threshold,
rate of decrease of maximum is above a second threshold, and average corresponds to average received power observed by the UE when the plurality of RAN node antenna ports identified by the configuration are unmuted; and
pattern corresponds to a pattern of received powers observed by the UE when the plurality of RAN node antenna ports identified by the configuration are unmuted.

In some variants, the UE can resume the receiving and measuring based on receiving from the RAN node one or more of the following:
a further configuration, for measurement and reporting by the UE, that is different than the configuration (i.e., under which the UE determined muting), and
a message scheduling the UE to receive data in radio resources associated with the first subset.

In some variants, the UE can resume the receiving and measuring based on determining that a duration since the first subset of the RAN node antenna ports were determined to be muted is approximately equal to a previous muting duration observed by the UE for the first subset.

In some variants, the UE can resume the receiving and measuring when the configuration (i.e., under which the UE determined muting) includes an upcoming reporting instance for which the UE should report measurements associated with the configured plurality of RAN node antenna ports. For example, the content of an upcoming CSI report being prepared by the UE matches the type of report that was observed to typically trigger the RAN node to reactivate ports.

In general, the UE not resuming measurement of antenna ports immediately after unmuting may cause temporary suboptimal performance for DL data reception but is not expected to lead to more severe events, such as radio link loss. It is expected that the UE will recover relatively quickly after detecting the unmuting of the antenna ports, e.g., at the next measurement occasion.

In some embodiments, the UE can continue receiving and measuring RS in a first portion of the radio resources that map to first subset after the determination that the first subset was muted, for various purposes. For example, the UE may periodically or occasionally verify that a port previously identified as muted remains muted, such as discussed above. The UE may perform this verification on the first portion of radio resources that occurs every N≥2 configured RS measurement occasion, every M seconds (or other predetermined timer period), etc.

Alternately or additionally, the UE can estimate interference due to other UEs and/or RAN nodes (e.g., other cells) based on these measurements of the first portion. For example, the UE can estimate other-cell interference levels by averaging power estimates from these radio resources over time. Such an estimate provides an RSSI-like estimate of all signal sources besides the serving cell. It may thus also be used for estimating spurious interference or inter-system interference in unlicensed scenarios.

In some embodiments, the RAN node may select a port-to-element mapping so that when part of the antenna panel is muted, the muted antenna elements correspond to antenna ports that map to radio resources grouped in one or more OFDM symbols (e.g., symbol pair), such that those OFDM symbols do not include radio resources that map to unmuted antenna ports. This enables the UE to enter a low-energy state during those OFDM symbols, as discussed above, but can also reduce RAN node energy consumption when no other signals are transmitted during those OFDM symbols.

Alternately or additionally, the RAN node may select the antenna ports to be muted such that all muted ports map to a subset of the RAN node's antenna panel and no unmuted ports map to that subset. In such case, the RAN node can turn off its transmitters that are coupled to that subset, thereby reducing energy consumption. In various embodiments, the subset can be various blocks or groups of antenna elements in any number or arrangement on the RAN node antenna panel, e.g., groups of 8, 16, 32 etc. antenna elements, upper/lower, left/right, interleaved, etc.

In embodiments where the UE sends a report to the RAN node after the muting occurs, the RAN node may determine from the report whether the UE has detected port muting and/or has refrained from receiving and measuring on muted ports and/or has resumed receiving and measuring on previously muted ports that have been unmuted. For example, if the RAN node unmutes a port but the contents of a UE report is still similar (e.g., 0, or close to 0) to when the port was muted, the RAN node may assume that the UE has not resumed processing of those ports. Likewise, the RAN node can detect that the UE has refrained from receiving and measuring on muted ports based on various types of indications from the UE, such as discussed above for UE embodiments.

In some embodiments, the RAN node can perform various operations to initiate or trigger the UE to resume receiving and measuring on previously muted ports that have been unmuted. Examples include fluctuation in power levels (e.g., temporary power decrease) on ports currently being received and measured by the UE (e.g., the second subset discussed above), reconfiguring CSI-RS resources or measurements (possibly without changing from the current value), configuring periodic measurements or reports, transmitting data, etc.

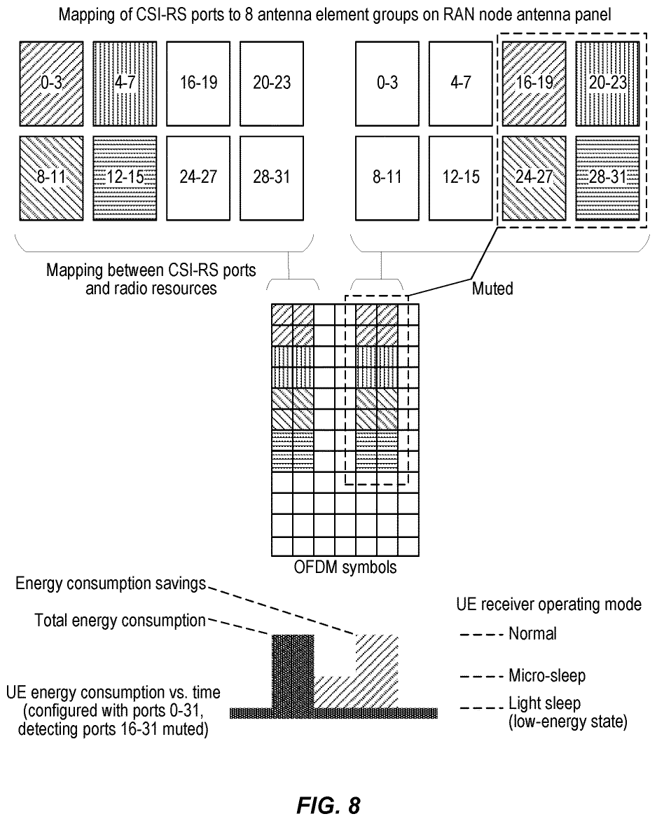

FIG. 8 shows an exemplary arrangement that illustrates various embodiments of the present disclosure. In this scenario, the RAN node transmits via an antenna panel that includes eight (8) antenna element groups, shown in an exemplary 2×4 grid. The RAN node also utilizes 32 CSI-RS (antenna) ports with indices 0-31, with groups of four CSI-RS ports mapped to the respective antenna element groups (e.g., 0-3, 4-7, etc.).

The middle part of FIG. 8 shows an exemplary allocation of CSI-RS radio resources (i.e., REs) within a resource grid of seven OFDM symbols and 12 OFDM sub-carriers (e.g., half resource block in time). In this example, CSI-RS radio resources are in symbols 0-1 and 4-5. FIG. 8 also shows the mapping between CSI-RS ports and CSI-RS radio resources. In particular, CSI-RS ports 0-15 mapped to the left-most four antenna element groups are also mapped to radio resources in symbols 0-1, while CSI-RS ports 16-31 mapped to the right-most four antenna element groups are also mapped to radio resources in symbols 4-5. The different shading patterns indicate detailed mapping between radio resources and CSI-RS ports/antenna element groups.

The bottom part of FIG. 8 shows UE energy consumption vs. time, on the same scale as the OFDM symbols in the middle part. In this scenario, the RAN node configures the UE with CSI-RS ports 0-31 but mutes CSI-RS ports 16-31 that map to the right-most half of the antenna panel and to the resources in symbols 3-4. Thus, the RAN node can turn off the power amplifier/radio frequency (PA/RF) circuitry chain driving the antenna panel during symbols 4-5, thereby reducing energy consumption.

According to embodiments of the present disclosure, the UE can detect that the RAN node has muted CSI-RS ports 16-31 during symbols 4-5. Since only muted CSI-RS ports map to symbols 4-5, the UE can put its receiver in light sleep operating mode after receiving symbol 1 and maintain it in this mode until the next symbol (e.g., next symbol 0) that includes radio resources that map to unmuted CSI-RS ports 0-15. The dark shaded area illustrates total UE energy consumption according to this example. The diagonal-shaded area, on the other hand, illustrates UE energy consumption savings versus conventional techniques, where the UE switches to a micro-sleep mode during symbols 2-3 and returns to normal operating mode during symbols 4-5, before switching to light-sleep mode afterwards.

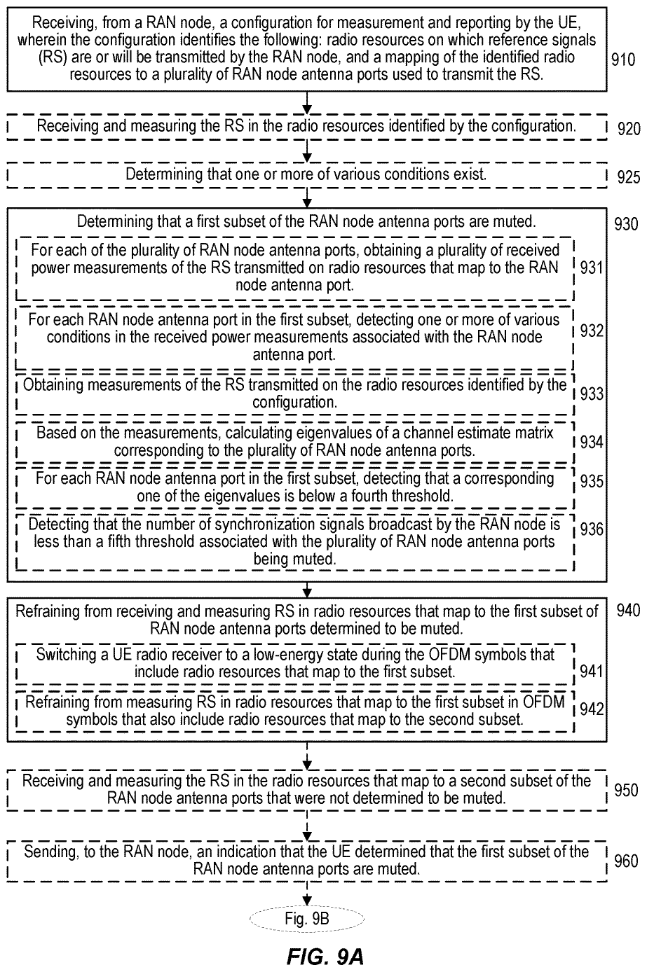

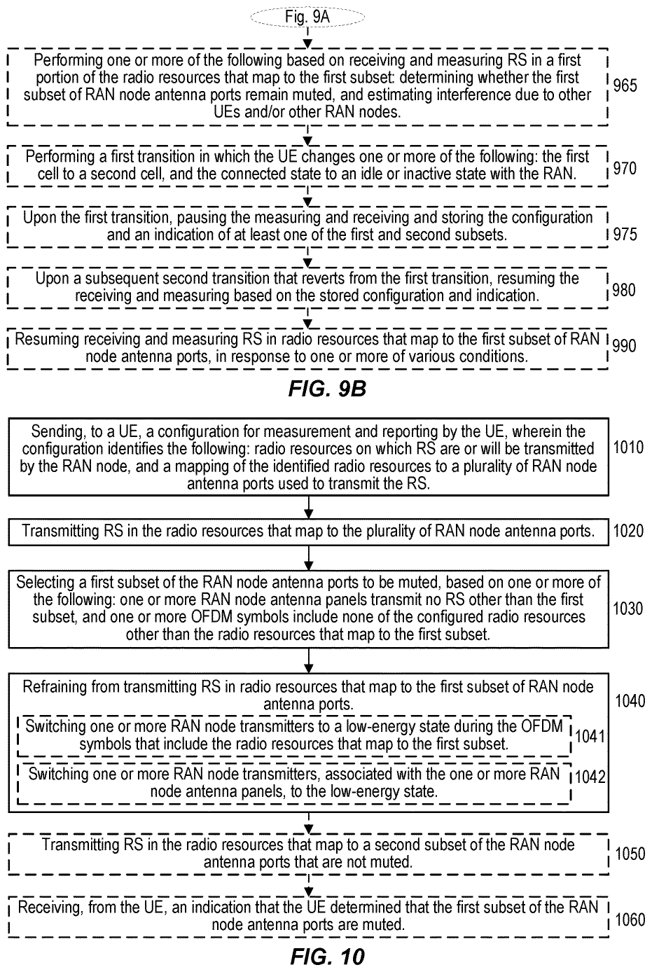

The embodiments described above can be further illustrated with reference to FIGS. 9-10, which show exemplary methods (e.g., procedures) for a UE and a RAN node, respectively. In other words, various features of operations described below correspond to various embodiments described above. These exemplary methods can be used cooperatively to provide various exemplary benefits and/or advantages. Although FIGS. 9-10 show specific blocks in a particular order, the operations of the respective methods can be performed in different orders than shown and can be combined and/or divided into blocks having different functionality than shown. Optional blocks or operations are indicated by dashed lines.

In particular, FIG. 9 shows a flow diagram of an exemplary method (e.g., procedure) for a UE configured to operate in a RAN, according to various embodiments of the present disclosure. The exemplary method can be performed by a UE (e.g., wireless device) such as described elsewhere herein.

The exemplary method can include the operations of block 910, where the UE can receive, from a RAN node, a configuration for measurement and reporting by the UE, wherein the configuration identifies the following: radio resources on which reference signals (RS) are or will be transmitted by the RAN node, and a mapping of the identified radio resources to a plurality of RAN node antenna ports used to transmit the RS. For example, the RS can be CSI-RS and the RAN node antenna ports can be CSI-RS ports.

The exemplary method can also include the operations of block 930, where the UE can determine that a first subset of the RAN node antenna ports are muted. The exemplary method can also include the operations of block 940, where the UE can subsequently refrain from receiving and measuring RS in radio resources that map to the first subset of RAN node antenna ports determined to be muted.

In some embodiments, the exemplary method can also include the operations of block 950, where while refraining from receiving and measuring RS in the radio resources that map to the first subset, the UE can receive and measure the RS in the radio resources that map to a second subset of the RAN node antenna ports that were not determined to be muted.

In some of these embodiments, receiving and measuring the RS in radio resources that map to a second subset in block 950 is performed in a first cell while the UE is in a connected state with the RAN. In such embodiments, the exemplary method can also include the following operations, labelled with corresponding block numbers:
(970) performing a first transition in which the UE changes one or more of the following: the first cell to a second cell, and the connected state to an idle or inactive state with the RAN;
(975) upon the first transition, pausing the measuring and receiving and storing the configuration and an indication of at least one of the first and second subsets; and
(980) upon a subsequent second transition that reverts from the first transition, resuming the receiving and measuring based on the stored configuration and indication.

In some of these embodiments, resuming the receiving and measuring based on the stored configuration and indication is conditioned upon the first transition and the second transition occurring at proximate times of day.

In some embodiments, determining that the first subset of the RAN node antenna ports are muted in block 930 is based on the operations of block 920, where the UE receives and measures the RS in the radio resources identified by the configuration. In some of these embodiments, the identified radio resources are periodic or semi-persistent in time and the configuration also identifies a schedule for reporting UE measurements of the RS transmitted on the radio resources. In such embodiments, determining that a first subset of the RAN node antenna ports are muted in block 930 is further based one or more of the following: the schedule for reporting is non-periodic in time, and one or more instances of the radio resources do not have corresponding instances in the schedule for reporting.

In other embodiments, determining that the first subset of the RAN node antenna ports are muted in block 930 includes the operations of sub-blocks 931-932. In sub-block 931, for each of the plurality of RAN node antenna ports, the UE obtains a plurality of received power measurements of the RS transmitted on radio resources that map to the RAN node antenna port. In sub-block 932, for each RAN node antenna port in the first subset, the UE detects one or more of the following conditions in the received power measurements associated with the RAN node antenna port:
an average of the received power measurements is below a first threshold;
one or more largest of the received power measurements are below a second threshold; and
the received power measurements deviate from an expected statistical distribution by at least a third threshold.

In some of these embodiments, one or more of the first threshold, the second threshold, and the third threshold are specific to each RAN node antenna port. In some of these embodiments, the plurality of received power measurements corresponds to a minimum measurement duration or a minimum number of measurements.

In some of these embodiments, determining that the first subset of the RAN node antenna ports are muted is further based on the RAN node antenna ports for which the one or more conditions (i.e., the conditions listed above) were detected being at least a predetermined number, fraction, or percentage of the plurality of RAN node antenna ports.

In some of these embodiments, determining that the first subset of the RAN node antenna ports are muted is further based on, for each RAN node antenna port in the first subset, detecting that the one or more conditions exist for at least a minimum duration.

In other of these embodiments, the plurality of RAN node antenna ports are associated with respective port indices and determining that the first subset of the RAN node antenna ports are muted is further based on the indices of the RAN node antenna ports, for which the one or more conditions were detected, meeting one or more of the following conditions:
having a predetermined numerical pattern; and
having a predetermined relationship with the indices of the RAN node antenna ports for which the one or more conditions were not detected (e.g., the second subset).

In other embodiments, determining that a first subset of the RAN node antenna ports are muted in block 930 includes the following operations, labelled with corresponding sub-block numbers:
(933) obtaining measurements of the RS transmitted on the radio resources identified by the configuration;
(934) based on the measurements, calculating eigenvalues of a channel estimate matrix corresponding to the plurality of RAN node antenna ports; and
(935) for each RAN node antenna port in the first subset, detecting that a corresponding one of the eigenvalues is below a fourth threshold.

In some embodiments, the exemplary method can also include the operations of block 990, where the UE can resume receiving and measuring RS in radio resources that map to the first subset of RAN node antenna ports, in response to one or more of the following:
determining that the first subset of RAN node antenna ports are no longer muted;
detecting that a number of synchronization signals (e.g., SSB) broadcast by the RAN node is at least a fifth threshold associated with the plurality of RAN node antenna ports being unmuted;
detecting one or more of the following conditions for received power measured by the UE on radio resources that map to the second subset;
   maximum is below a first threshold,
   rate of decrease of maximum is above a second threshold, and
   average corresponds to average received power observed by the UE when the plurality of RAN node antenna ports identified by the configuration are unmuted;
receiving from the RAN node one or more of the following:
   a further configuration, for measurement and reporting by the UE, that is different than the configuration, and
   a message scheduling the UE to receive data in radio resources associated with the first subset of RAN node antenna ports;
a duration since determining that the first subset of the RAN node antenna ports are muted is approximately equal to a previous muting duration observed by the UE for the first subset; and
the configuration includes an upcoming reporting instance for which the UE should report measurements associated with the configured plurality of RAN node antenna ports.

In some of these embodiments, determining that the first subset of RAN node antenna ports are muted in block 930 includes the operations of sub-block 936, where the UE can detect that the number of synchronization signals (e.g., SSB) broadcast by the RAN node is less than the fifth threshold.

In some embodiments, the exemplary method can also include the operations of block 965, where the UE can perform one or more of the following based on receiving and measuring RS in a first portion of the radio resources that map to the first subset: switching a UE radio receiver to a low-energy state (e.g., light sleep) during the OFDM symbols that include radio resources that map to the first subset; and refraining from measuring RS in radio resources that map to the first subset in OFDM symbols that also include radio resources that map to the second subset. FIG. 8 shows some examples of these operations.

In some embodiments, the exemplary method can also include the operations of block 960, where the UE can send, to the RAN node, an indication that the UE determined that the first subset of the RAN node antenna ports are muted. The indication is one of the following:
actual or average UE RS measurement values for RAN node antenna ports of the first subset;
zero or minimum RS measurement values that are representative of RAN node antenna port muting;
a preferred precoder associated with less than the plurality of RAN node antenna ports identified by the configuration; and
a preferred channel rank associated with less than the plurality of RAN node antenna ports identified by the configuration.

In some embodiments, one or more of determining that the first subset of the RAN node antenna ports are muted (block 930) and refraining from receiving and measuring RS in radio resources that map to the first subset (block 940) is performed based on the UE determining in block 925 that one or more of the following conditions exist:
an average or a minimum of one or more of the following measured by the UE in the radio resources identified by the configuration is greater than a threshold: RS received power, or RS received quality;
the UE is static or is moving more slowly than a threshold speed; and
one or more specific services or applications are not running in the UE.
   For example, when one or more of the above conditions exists, the UE can stop (or refrain from) checking for muted antenna ports or, if it does check for muted antenna ports, the UE can continue receiving and measuring RS in radio resources that map to antenna ports determined to be muted.

In addition, FIG. 10 shows a flow diagram of an exemplary method (e.g., procedure) for a RAN node configured to transmit RS to UEs, according to various embodiments of the present disclosure. The exemplary method can be performed by a RAN node (e.g., base station, eNB, gNB, ng-eNB, en-gNB, etc., or components thereof) such as described elsewhere herein.

The exemplary method can include operations of block 1010, where the RAN node can send, to a UE, a configuration for measurement and reporting by the UE. The configuration identifies the following: radio resources on which RS are or will be transmitted by the RAN node, and a mapping of the identified radio resources to a plurality of RAN node antenna ports used to transmit the RS. For example, the RS can be CSI-RS and the RAN node antenna ports can be CSI-RS ports.

The exemplary method can also include the operations of block 1020, where the RAN node can transmit RS in the radio resources that map to the plurality of RAN node antenna ports. The exemplary method can also include the operations of block 1030, where the RAN node can select a first subset of the RAN node antenna ports to be muted, based on one or more of the following:
a first portion of a RAN node antenna panel transmits no RS other than the first subset, and
one or more OFDM symbols include none of the configured radio resources other than the radio resources that map to the first subset.

The exemplary method can also include the operations of block 1040, where the RAN node can subsequently refrain from transmitting RS in radio resources that map to the first subset of RAN node antenna ports.

In some embodiments, refraining from transmitting RS in radio resources that map to the first subset of RAN node antenna ports in block 1040 includes one or more of the following operations, labelled with corresponding sub-block numbers:
(1041) switching one or more RAN node transmitters to a low-energy state during the OFDM symbols that include the radio resources that map to the first subset; and
(1042) switching one or more RAN node transmitters coupled to the first portion of the RAN node antenna panel, to the low-energy state.

In some embodiments, the exemplary method can also include the operations of block 1050, where while refraining from transmitting RS in the radio resources that map to the first subset, the RAN node can transmit RS in the radio resources that map to a second subset of the RAN node antenna ports that are not muted. In some of these embodiments, one or more of the following applies: the second subset are associated with a second portion of the RAN node antenna panel, and the second subset map to radio resources in one or more further OFDM symbols.

In some embodiments, the exemplary method can also include the operations of block 1060, where the RAN node can receive, from the UE, an indication that the UE determined that the first subset of the RAN node antenna ports are muted. The indication is one of the following:
actual or average UE RS measurement values for RAN node antenna ports of the first subset;
zero or minimum RS measurement values that are representative of RAN node antenna port muting;
a preferred precoder associated with less than the plurality of RAN node antenna ports identified by the configuration; and
a preferred channel rank associated with less than the plurality of RAN node antenna ports identified by the configuration.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

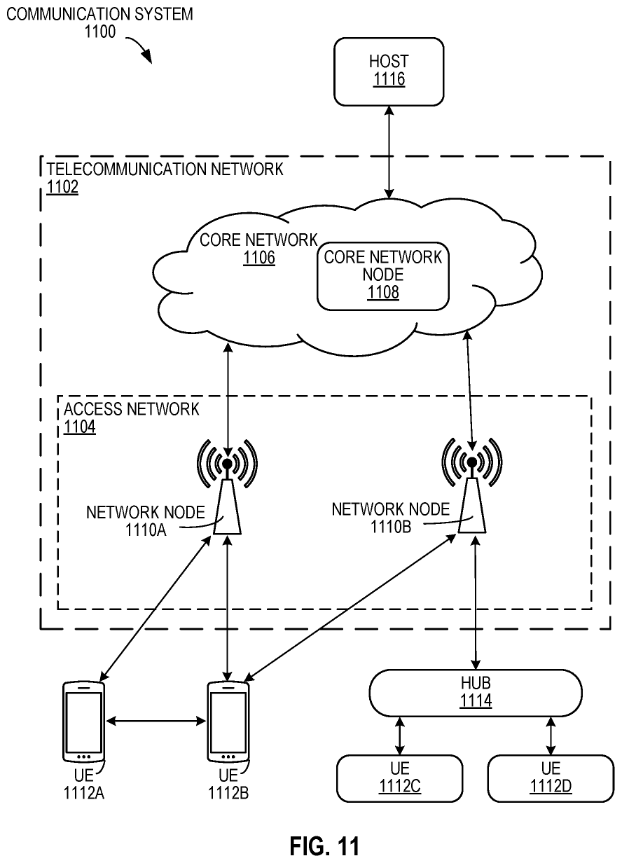

FIG. 11 shows an example of a communication system 1100 in accordance with some embodiments. In this example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3GPP access node or non-3GPP access point. The network nodes 1110 facilitate direct or indirect connection of UEs, such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

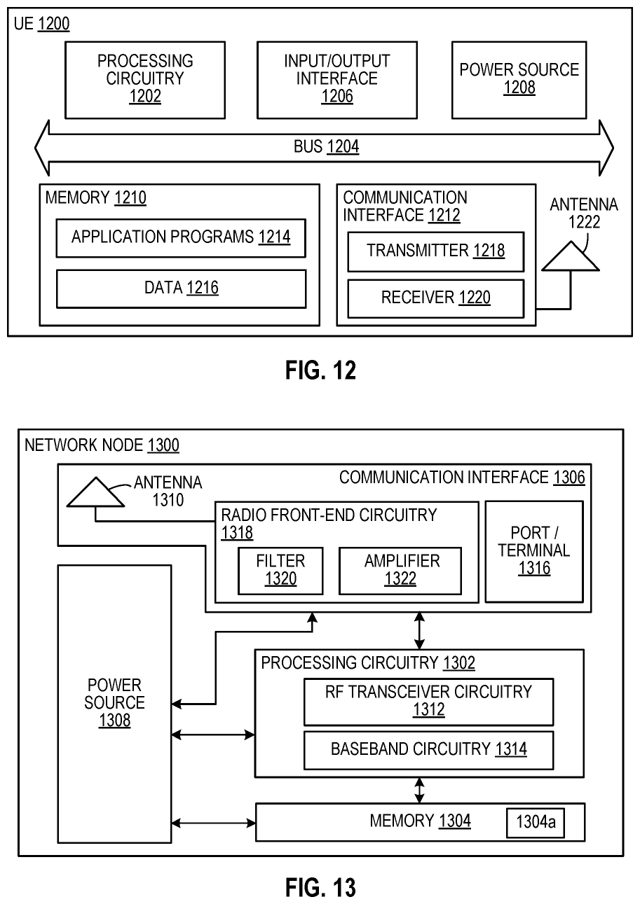

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (cUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (e.g., radio base stations, Node Bs, eNBs, gNBs), etc.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions (collectively denoted computer program product 1304a) capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

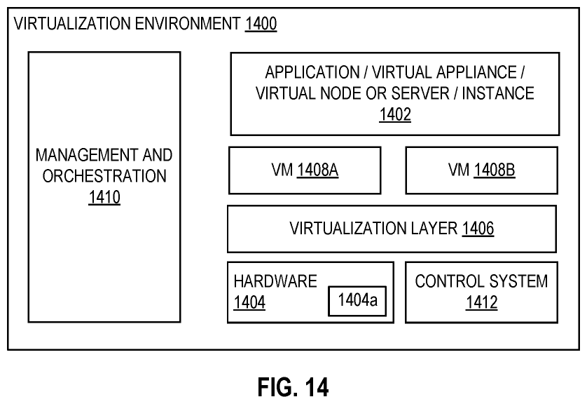

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions (collectively denoted computer program product 1404a) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset: this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1.-39. (canceled)

40. A method for a user equipment (UE) configured to operate in a radio access network (RAN), the method comprising:
receiving, from a RAN node, a configuration for measurement and reporting by the UE, wherein the configuration identifies the following:
radio resources on which reference signals (RS) are or will be transmitted by the RAN node, and
a mapping of the identified radio resources to a plurality of RAN node antenna ports used to transmit the RS;
based on receiving and measuring the RS in the radio resources identified by the configuration, determining that a first subset of the RAN node antenna ports are muted; and
subsequently refraining from receiving and measuring RS in radio resources that map to the first subset of RAN node antenna ports determined to be muted.

41. The method of claim 40, further comprising, while refraining from receiving and measuring RS in the radio resources that map to the first subset, receiving and measuring the RS in the radio resources that map to a second subset of the RAN node antenna ports that were not determined to be muted.

42. The method of claim 41, wherein:
receiving and measuring the RS in radio resources that map to a second subset is performed in a first cell while in a connected state with the RAN;
the method further comprises:
performing a first transition in which the UE changes one or more of the following: the first cell to a second cell, and the connected state to an idle or inactive state with the RAN;
performing the following upon the first transition: pausing the measuring and receiving, and storing the configuration and an indication of at least one of the first and second subsets; and
upon a subsequent second transition that reverts from the first transition, resuming the receiving and measuring based on the stored configuration and indication.

43. The method of claim 42, wherein resuming the receiving and measuring based on the stored configuration and indication is conditioned upon the first transition and the second transition occurring at proximate times of day.

44. The method of claim 40, wherein:
the identified radio resources are periodic or semi-persistent in time;
the configuration also identifies a schedule for reporting UE measurements of the RS transmitted on the radio resources; and
determining that the first subset of the RAN node antenna ports are muted is further based one or more of the following:
the schedule for reporting is non-periodic in time; and
one or more instances of the radio resources do not have corresponding instances in the schedule for reporting.

45. The method of claim 40, wherein determining that the first subset of the RAN node antenna ports are muted comprises:
for each of the plurality of RAN node antenna ports, obtaining a plurality of received power measurements of the RS transmitted on radio resources that map to the RAN node antenna port; and
for each RAN node antenna port in the first subset, detecting one or more of the following conditions in the received power measurements associated with the RAN node antenna port:
an average of the received power measurements is below a first threshold;
one or more largest of the received power measurements are below a second threshold; and
the received power measurements deviate from an expected statistical distribution by at least a third threshold.

46. The method of claim 45, wherein determining that the first subset of the RAN node antenna ports are muted is further based on the RAN node antenna ports, for which the one or more conditions were detected, being at least a predetermined number, fraction, or percentage of the plurality of RAN node antenna ports.

47. The method of claim 45, wherein:
the plurality of RAN node antenna ports are associated with respective port indices; and
determining that the first subset of the RAN node antenna ports are muted is further based on the indices of the RAN node antenna ports, for which the one or more conditions were detected, meeting one or more of the following conditions:
having a predetermined numerical pattern; and
having a predetermined relationship with the indices of the RAN node antenna ports for which the one or more conditions were not detected.

48. The method of claim 45, wherein determining that the first subset of the RAN node antenna ports are muted is further based on detecting that, for each RAN node antenna port in the first subset, the one or more conditions exist for at least a minimum duration.

49. The method of claim 45, wherein the plurality of received power measurements corresponds to one of the following: a minimum measurement duration, or a minimum number of measurements.

50. The method of claim 40, further comprising sending, to the RAN node, an indication that the UE determined that the first subset of the RAN node antenna ports are muted, wherein the indication is one of the following:
actual or average UE RS measurement values for RAN node antenna ports of the first subset;
zero or minimum RS measurement values that are representative of RAN node antenna port muting;
a preferred precoder associated with less than the plurality of RAN node antenna ports identified by the configuration; and
a preferred channel rank associated with less than the plurality of RAN node antenna ports identified by the configuration.

51. The method of claim 40, wherein one or more of determining that the first subset of the RAN node antenna ports are muted and refraining from receiving and measuring RS in radio resources that map to the first subset, is performed based on determining that one or more of the following conditions exist:
an average or a minimum of one or more of the following measured by the UE in the radio resources identified by the configuration is greater than a threshold: RS received power, or RS received quality;
the UE is static or is moving more slowly than a threshold speed; and
one or more specific services or applications are not running in the UE.

52. The method of claim 40, wherein the RS are channel state information RS (CSI-RS) and the RAN node antenna ports are CSI-RS ports.

53. A user equipment (UE) configured to operate in a radio access network (RAN), the UE comprising:
communication interface circuitry configured to communicate with a RAN node; and
processing circuitry operatively coupled to the communication interface circuitry, wherein the processing circuitry and the communication interface circuitry are configured to:
receive, from the RAN node, a configuration for measurement and reporting by the UE, wherein the configuration identifies the following:
radio resources on which reference signals (RS) are or will be transmitted by the RAN node, and
a mapping of the identified radio resources to a plurality of RAN node antenna ports used to transmit the RS;
based on receiving and measuring the RS in the radio resources identified by the configuration, determine that a first subset of the RAN node antenna ports are muted; and
subsequently refrain from receiving and measuring RS in radio resources that map to the first subset of RAN node antenna ports determined to be muted.

54. The UE of claim 53, wherein the processing circuitry and the communication interface circuitry are further configured to, while refraining from receiving and measuring RS in the radio resources that map to the first subset, receive and measure the RS in the radio resources that map to a second subset of the RAN node antenna ports that were not determined to be muted.

55. The UE of claim 53, wherein:
the identified radio resources are periodic or semi-persistent in time;
the configuration also identifies a schedule for reporting UE measurements of the RS transmitted on the radio resources; and
the processing circuitry and the communication interface circuitry are configured to determine that the first subset of the RAN node antenna ports are muted further based one or more of the following:
the schedule for reporting is non-periodic in time; and
one or more instances of the radio resources do not have corresponding instances in the schedule for reporting.

56. The UE of claim 55, wherein the processing circuitry and the communication interface circuitry are configured to determine that the first subset of the RAN node antenna ports are muted based on:
for each of the plurality of RAN node antenna ports, obtaining a plurality of received power measurements of the RS transmitted on radio resources that map to the RAN node antenna port; and
for each RAN node antenna port in the first subset, detecting one or more of the following conditions in the received power measurements associated with the RAN node antenna port:
an average of the received power measurements is below a first threshold;
one or more largest of the received power measurements are below a second threshold; and
the received power measurements deviate from an expected statistical distribution by at least a third threshold.

57. The method of claim 55, wherein the processing circuitry and the communication interface circuitry are configured to determine that the first subset of the RAN node antenna ports are muted further based on the RAN node antenna ports, for which the one or more conditions were detected, being at least a predetermined number, fraction, or percentage of the plurality of RAN node antenna ports.

58. The method of claim 55, wherein:
the plurality of RAN node antenna ports are associated with respective port indices; and
the processing circuitry and the communication interface circuitry are configured to determine that the first subset of the RAN node antenna ports are muted further based on the indices of the RAN node antenna ports, for which the one or more conditions were detected, meeting one or more of the following conditions:
having a predetermined numerical pattern; and
having a predetermined relationship with the indices of the RAN node antenna ports for which the one or more conditions were not detected.

59. A non-transitory, computer-readable medium storing computer-executable instructions that, when executed by processing circuitry of a user equipment (UE) configured to operate in a radio access network (RAN), configure the UE to perform the method of claim 40.
